(19) United States
(12) Patent Application Publication
(10) Pub. No.: US 2024/0127212 A1
(43) Pub. Date: Apr. 18, 2024

(54) SYSTEM AND METHOD FOR ENABLING PAYMENTS OVER MESSAGING

(71) Applicant: Gupshup Inc., Fremont, CA (US)

(72) Inventors: Beerud Dilip Sheth, Fremont, CA (US); Kunal Talreja, Mumbai (IN); Nirmesh Mehta, Mumbai (IN)

(21) Appl. No.: 18/349,204

(22) Filed: Jul. 10, 2023

Related U.S. Application Data
(60) Provisional application No. 63/359,851, filed on Jul. 10, 2022.

(51) Int. Cl. G06Q 20/14; G06Q 20/04; G06Q 20/22; G06Q 20/32; G06Q 20/40

(52) U.S. Cl. CPC G06Q 20/14; G06Q 20/047; G06Q 20/227; G06Q 20/3255; G06Q 20/4014

(57) ABSTRACT

A bill payment system (BPS) for executing a one-click bill payment (OCBP) for payment transactions at merchant locations is provided. The BPS receives entity information, a messaging channel, and a selection of three templates from an entity. The BPS validates the three templates. The BPS receives a user identifier and payment details for a payment transaction from a merchant, and incorporates them into a first, second, and third templates. The BPS generates and incorporates an OCBP link into the first and second templates. The BPS incorporates the first, second, and third templates into a first, second, and third notifications, respectively. The BPS sends the notifications to the user via the messaging channel. Upon clicking the OCBP link in the first or second notification, a list of payment methods is sent to the user. Upon receiving the payment within stipulated time, the BPS sends the third notification to the user.

### CROSS-REFERENCE TO RELATED APPLICATIONS

This application claims priority to and the benefit of the provisional patent application titled “A System and Method to Enable Payments Over Messaging”, application No. 63/359,851, filed in the United States Patent and Trademark Office on Jul. 10, 2022. The specification of the above referenced patent application is incorporated herein by reference in its entirety.

### BACKGROUND

An enterprise or an organization typically notifies its customers, herein referred to as “users”, via a payment notification, that a payment is required for services they received. The enterprise or the organization sends the payment notification, typically containing a large amount of payment-related information, to end users, as unstructured text messages, primarily via a short message service (SMS) message. Typically, these unstructured text messages, together with associated metadata, contain data required to make a payment, for example, an amount to be paid, destination account details or receiver details to which the payment is to be made and a reference, an invoice number, or an account number relating to which the payment is being made. However, after receiving the SMS message, the users still need to navigate through various steps to make the payment. The steps may include, for example, logging in to an account, manually searching for and re-entering the data or information contained in the unstructured text messages, etc. These steps are lengthy and error-prone, causing friction in the entire payment process, which delays the payment transaction, something that both parties, that is, the enterprise or the organization and the users, would like to avoid.

Moreover, an enterprise or an organization typically notifies its customers or users, that a payment is due for services they received, for example, via short message service (SMS) messages, messages sent through a messaging channel such as a WhatsApp® messaging channel of WhatsApp LLC, etc. These notifications are referred to as payment due reminder messages or payment request messages. Conventional payment due reminder messages have the following drawbacks: 1) Since the users do not have an option to perform a direct action on the payment due reminder messages, engagement is low; 2) in order to make a payment, the users must switch to a payment channel; 3) the payment process is tedious and time consuming; and 4) late payments by users caused by non-actionable payment due reminder messages driven by increased cognitive load.

In general, there are several mechanisms to speed up payment processing, including using hyperlinks and buttons. These mechanisms often require a modification in the method used to generate these payment due reminder messages or payment request messages. Depending on the channels of communication being used, the modified formats may be different for different users.

Furthermore, the payment due reminder messages or the payment request messages are generated in systems that are separate from systems where payment processing or account management is performed. At times, the generation of payment due reminder messages or payment request messages happens on a large scale, with millions of messages being generated in a few seconds. Consequently, it is not easy to modify the system to generate payment due reminder messages or payment request messages in an appropriate format.

FIG. 1 (prior art) illustrates a block diagram of a process flow for a financial transaction between a merchant and a user. On receiving a payment request event, a message generation module 101 at the merchant end generates a payment request message with the required information. The generated payment request message is sent via a messaging channel 102, for example, a short messaging service (SMS) messaging channel or a WhatsApp® messaging channel, to a messaging application 103 on an end user device. The end user manually opens a payment collection interface 104 at the merchant end, often in the form of a website or an application, and enters payment information. On submitting the information, the submitted information is sent to a payment processing module 105 for payment processing. The payment request messages sent to the user are non-actionable reminder messages that don't provide the user with the option to take direct action on the payment request message. Furthermore, in order to pay the merchant after receiving the payment request message, the user must switch to a separate payment channel. Therefore, there is a long-felt need for an actionable payment reminder messages.

Low engagement, time-consuming payment process, and late payments are caused by non-actionable reminder messages, requiring users to switch channels, and increased cognitive load.

Hence, there is a long-felt need for a method and a system for facilitating online payment transactions through messages by creating and transmitting a payment request message comprising a payment link. Furthermore, there is a need for a method and a system for converting conventional payment due reminders into payment actionable messages.

### SUMMARY OF THE INVENTION

This summary is provided to introduce a selection of concepts in a simplified form that are further disclosed in the detailed description of the invention. This summary is not intended to determine the scope of the claimed subject matter.

The method and the system disclosed herein address the above-recited need for creating and transmitting a payment request message comprising a payment link. Furthermore, the method and the system disclosed herein provide a mechanism for converting conventional payment due reminders into payment actionable messages.

A method and a system for executing a one-click bill payment for a payment transaction at a merchant location are provided. The method and the system disclosed herein employ a bill payment system (BPS) configured to define computer program instructions executable by at least one processor for executing a one-click bill payment for a payment transaction performed at a merchant location. The BPS is configured to manage payment transactions performed at merchant locations. The BPS receives entity information and a selection of a messaging channel from an entity. As used herein, the term “entity” refers to one of a business entity, a company, an enterprise, a division of the enterprise, an entity or a brand used by the enterprise, an organization, etc., identified by or associated with one or more brands of products and/or services, and that intends to send one of payment due reminder messages or payment request messages to a user. Also as used herein, the term “user” refers to an individual to whom the entity wants to send one of a payment due reminder messages or payment request messages. The term “entity” refers to the name of a business, a company, an enterprise, an organization, etc., that sends the payment due reminder messages or payment request messages to a user device of the user. The entity is, for example, a for-profit business, a not-for-profit entity, a governmental entity, or a small business. Wherever reference is made to an entity taking or receiving an action, the reference refers to a developer or another person who takes or receives the action on behalf of the entity, or an application that takes or receives the action on behalf of the entity. Also, as used herein, the term “entity information” refers to a brand name, a brand icon, and/or a brand logo of the entity or a brand requesting to transmit the payment request message to the user's mobile number.

The messaging channel is, one of a WhatsApp messaging channel of WhatsApp LLC, a short message service (SMS) messaging channel, and a WhatsApp® with fallback to SMS messaging channel. As used herein, “channel” exemplarily refers to a SMS messaging channel, a WhatsApp® messaging channel, a rich communication services (RCS) messaging channel, an iMessage® messaging channel of Apple Inc., a Viber® messaging channel of Viber Media SARL, etc. Also, as used herein, “messaging channel”, “data messaging channel”, “data messaging application”, “data messaging platform”, and “rich messaging platform”, exemplarily refer to RCS, Whats App®, iMessage®, Viber®, etc.

In an embodiment, the method disclosed herein comprises sending payment request messages on one or more data messaging channels or rich messaging channels or messaging channels, for example, Rich Communication Services (RCS), WhatsApp® of WhatsApp LLC, iMessage® of Apple, Inc., Business Chat of Apple, Inc., Viber® of Viber Media SARL, Telegram® of Telegram FZ-LLC, Facebook® Messenger of Facebook, Inc., Google Business Messages of Google LLC, Signal® Private Messenger of Signal Technology Foundation, or any other messaging channels that use data to communicate a message or that support rich messaging features and rich elements comprising, for example, images, videos, rich cards, carousels, interactive buttons, etc.

The messaging channels or the data messaging channels or the rich messaging channels disclosed above are supported by a data messaging application on a user device, and a data messaging platform, for example, rich communication services (RCS), WhatsApp®, iMessage®, Viber®, etc. Most of these data messaging platforms support business messaging that enables a brand, or a developer on behalf of a brand, or an application on behalf of a brand, to send and receive messages over a data network to and from users of the data messaging applications. Some data messaging platforms such as Signal® do not currently support business messaging but may do so in the future. Some of the rich messaging platforms, for example, RCS, Whats App®, iMessage®, Viber®, etc., identify the user by their mobile number. Other rich messaging platforms, for example, Facebook® Messenger, not only allow users to use an identifier other than a mobile number, but also permit users to link a mobile number with their account. Some other rich messaging platforms, for example, Google Business Messages, use an identifier other than mobile number and do not currently support a mechanism to link their channel identifier with a mobile number at the platform level, but enable users that interact with a brand to provide and validate a mobile number to a chatbot, thereby establishing a mapping between an identifier used by the rich messaging platform and the mobile number of the user.

In the method and the system disclosed herein, the bill payment system (BPS) sends multiple templates to the entity and receives a selection of three templates from the entity. The three templates comprise one of a first template, a second template, a third template, and any combination thereof. The BPS validates the three templates. The BPS receives a user identifier and payment details for a payment transaction from a merchant and incorporates the received entity information and the payment details into the first template, the second template, and the third template. The BPS generates and incorporates a one-click bill payment link into the first template and the second template. The BPS incorporates the first template into a first notification to be sent to a user. The BPS incorporates the second template into a second notification to be sent to the user. The BPS incorporates the third template into a third notification to be sent to the user. In an embodiment, the BPS sends the first notification, the second notification, and the third notification to the user via the WhatsApp® messaging channel only if the entity has a WhatsApp® Enterprise account with the BPS. In another embodiment, the BPS sends the first notification, the second notification, and the third notification to the user via the short message service (SMS) messaging channel only if the entity has an SMS Enterprise account with the BPS. In another embodiment, the BPS sends the first notification, the second notification, and the third notification to the user via both the WhatsApp® channel and the SMS channel only if the entity has both a WhatsApp® Enterprise account and a SMS Enterprise account with the BPS.

The bill payment system (BPS) sends the first notification to the user via the selected messaging channel. If the selected messaging channel is the WhatsApp® messaging channel with fallback to short message service (SMS) messaging channel, the BPS first sends the first notification to the user using the WhatsApp® messaging channel, and if the first notification does not reach the user, then the BPS sends the first notification to the user using the SMS messaging channel. Upon the user clicking the one-click bill payment link contained in the first notification, a payment partner of the BPS sends a list of payment methods to the user. Upon the payment partner of the BPS receiving the payment within a stipulated time via one or more of the payment methods, the BPS sends the third notification to the user via the selected messaging channel. If the selected messaging channel is the WhatsApp® messaging channel with fallback to SMS messaging channel, the BPS first sends the third notification to the user using the WhatsApp® messaging channel, and if the third notification does not reach the user, then the BPS sends the third notification to the user using the SMS messaging channel. Upon the payment partner of the BPS successfully receiving the payment via one or more of the payment methods, the BPS sends a payment receipt information to the merchant in real time.

Upon the payment partner of the bill payment system (BPS) not receiving the payment within the stipulated time, the BPS sends the second notification to the user via the selected messaging channel. If the selected messaging channel is the WhatsApp® messaging channel with fallback to short message service (SMS) messaging channel, the BPS first sends the second notification to the user using the WhatsApp® messaging channel, and if the second notification does not reach the user, then the BPS sends the second notification to the user using the SMS messaging channel. Upon the user clicking the one-click bill payment link contained in the second notification, the payment partner of the BPS sends a list of payment methods to the user. Upon the payment partner of the BPS receiving the payment via one or more of the payment methods, the BPS sends the third notification to the user via the selected messaging channel. If the selected messaging channel is the WhatsApp® messaging channel with fallback to SMS messaging channel, the BPS first sends the third notification to the user using the WhatsApp® messaging channel, and if the third notification does not reach the user, then the BPS sends the third notification to the user using the SMS messaging channel. Upon the payment partner of the BPS successfully receiving the payment via one or more of the payment methods, the BPS sends the payment receipt information to the merchant in real time.

Upon the payment partner of the bill payment system (BPS) not receiving the payment via one or more of the payment methods within a stipulated time, even after sending the first notification and the second notification, the BPS aborts the one-click bill payment transaction and sends a notification to the merchant that the one-click bill payment transaction has been aborted due to non-payment of bill amount by the user even after sending the first notification and the second notification.

### BRIEF DESCRIPTION OF THE DRAWINGS

The foregoing summary, as well as the following detailed description of the invention, is better understood when read in conjunction with the appended drawings. For illustrating the embodiments herein, exemplary constructions of the embodiments are shown in the drawings. However, the embodiments herein are not limited to the specific methods and components disclosed herein. The description of a method step or a component referenced by a numeral in a drawing is applicable to the description of that method step or that component shown by that same numeral in any subsequent drawing herein.

FIG. 1 (prior art) illustrates a block diagram of a process flow for a financial transaction between a merchant and a user.

FIGS. 2A-2B illustrate a flowchart of an embodiment of a method for executing a one-click bill payment for a payment transaction at a merchant location.

FIG. 3 exemplarily illustrates a schematic showing a process flow of an embodiment of the method for executing a one-click bill payment for a payment transaction at a merchant location.

FIG. 4 exemplarily illustrates an architectural block diagram of an exemplary implementation of a system 400 for executing a one-click bill payment for a payment transaction at a merchant location.

FIGS. 5A-5B exemplarily illustrates screenshots of graphical user interfaces rendered by a bill payment system.

FIG. 5C exemplarily illustrates a screenshot of a graphical user interface rendered by a messaging client on a user device, displaying first notification sent to the user.

FIG. 5D exemplarily illustrates a link for invoking a list of payment methods.

FIG. 5E exemplarily illustrates a screenshot of a graphical user interface rendered by a messaging client on a user device, displaying a list of payment methods to the user.

FIG. 5F exemplarily illustrates a screenshot of a graphical user interface rendered by a messaging client on a user device, displaying third message sent to the user.

FIG. 5G exemplarily illustrates screenshot of graphical user interfaces rendered by a messaging client on a user device, displaying a second message sent to the user.

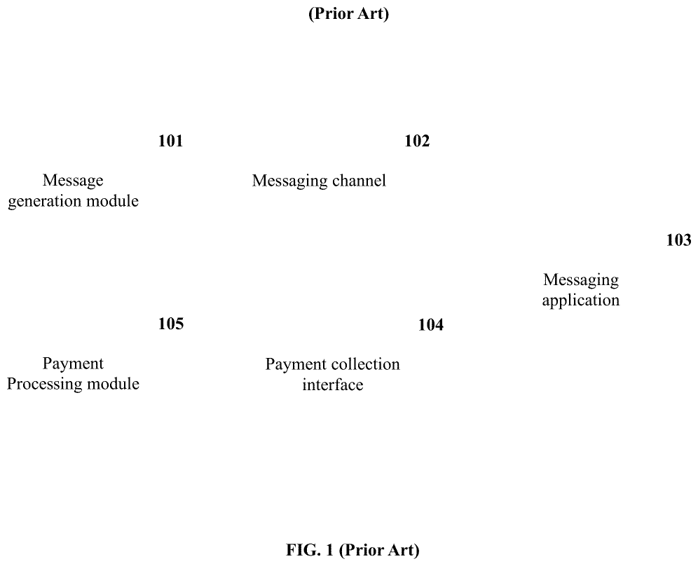

### DETAILED DESCRIPTION OF THE INVENTION

Various aspects of the disclosure herein are embodied as a system, a method, or a non-transitory, computer-readable storage medium having one or more computer-readable program codes stored thereon. Accordingly, various embodiments of the disclosure herein take the form of an entirely hardware embodiment, an entirely software embodiment comprising, for example, microcode, firmware, software, etc., or an embodiment combining software and hardware aspects that are referred to herein as a “system”, a “module”, an “engine”, a “circuit”, or a “unit”.

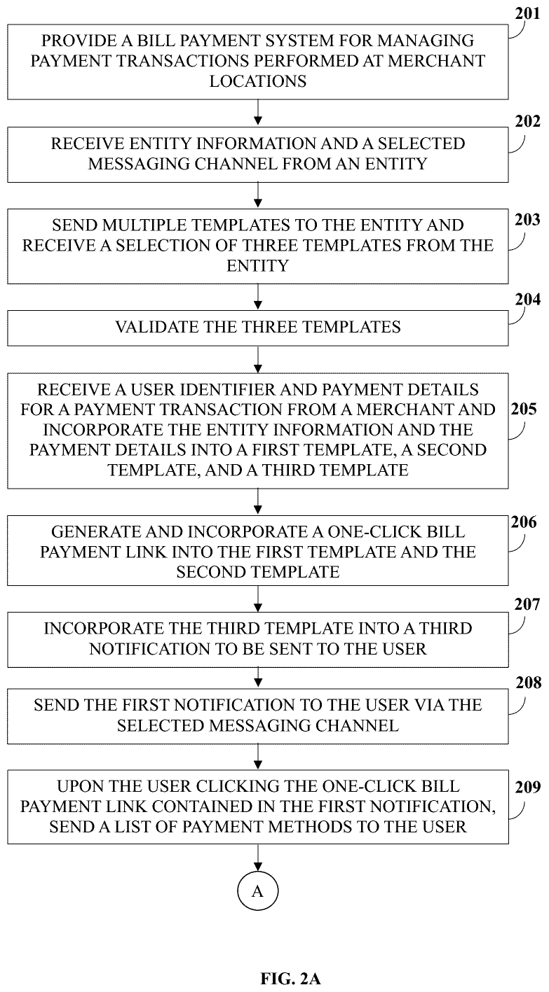

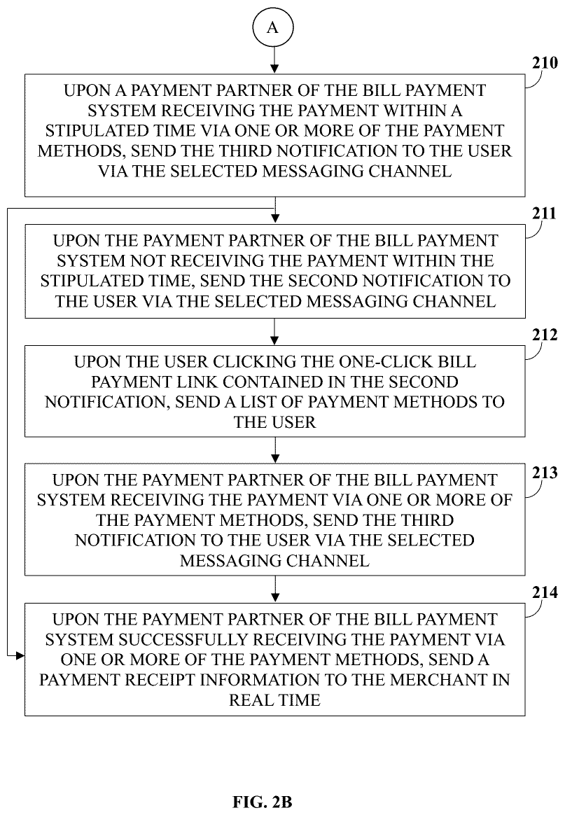

FIGS. 2A-2B illustrates a flowchart of an embodiment of a method for executing a one-click bill payment for a payment transaction at a merchant location. The method employs 201 a bill payment system (BPS) configured to define computer program instructions executable by at least one processor for executing a one-click bill payment for payment transactions at the merchant locations. The BPS receives 202 entity information and a selected messaging channel from an entity. In an embodiment, the method disclosed herein comprises sending one of payment due reminder messages or payment request messages on one or more data messaging channels or rich messaging channels or messaging channels, for example, Rich Communication Services (RCS), Whats App®, iMessage®, Business Chat, Viber®, Telegram®, Facebook® Messenger, Google Business Messages, Signal® Private Messenger, or any other messaging channels that use data to communicate a message or that support rich messaging features and rich elements comprising, for example, images, videos, rich cards, carousels, interactive buttons, etc. The user device is addressed by the user's mobile number or by an identifier mapped to the user's mobile number.

In an embodiment, the bill payment system (BPS) is implemented as a web-based platform hosted on a server or a network of servers accessible via a network. In another embodiment, the BPS is implemented in a cloud computing environment. As used herein, “cloud computing environment” refers to a processing environment comprising configurable, computing, physical, and logical resources, for example, networks, servers, storage media, virtual machines, applications, services, etc., and data distributed over a network, for example, the internet. The cloud computing environment is one of a private cloud, a public cloud, a hybrid cloud, etc. The cloud computing environment provides an on-demand network access to a shared pool of the configurable computing physical and logical resources. In an embodiment, the BPS is a cloud computing-based platform implemented as a service for creating and transmitting one of a payment due reminder messages or payment request messages. For example, the BPS is configured as a software as a service (SaaS) platform or a cloud-based software as a service (CSaaS) platform that creates and transmits one of a payment due reminder messages or payment request messages. In another embodiment, the BPS is implemented as a cloud platform service also known as Platform as a Service (PaaS). In another embodiment, the BPS is implemented as an on-premise software installed and run on computers on the premises of an organization. In another embodiment, the BPS is implemented as a communications Platform as a Service (CPaaS) or payments as a service (Paas).

The bill payment system (BPS) sends 203 multiple templates to the entity and receives a selection of three templates from the entity. The three templates comprise one of a first template, a second template, a third template, and any combination thereof. The BPS validates 204 the three templates. The BPS receives 205 a user identifier and payment details for a payment transaction from a merchant and incorporates the received entity information and the payment details into the first template, the second template, and the third template. The BPS generates and incorporates 206 a one-click bill payment link into the first template and the second template. The BPS incorporates the first template into a first notification to be sent to a user. The BPS incorporates the second template into a second notification to be sent to the user. The BPS incorporates 207 the third template into a third notification to be sent to the user. In an embodiment, the BPS sends the first notification, the second notification, and the third notification to the user via the WhatsApp® messaging channel only if the entity has a WhatsApp® Enterprise account with the BPS. In another embodiment, the BPS sends the first notification, the second notification, and the third notification to the user via the short message service (SMS) messaging channel only if the entity has an SMS Enterprise account with the BPS. In another embodiment, the BPS sends the first notification, the second notification, and the third notification to the user via both the WhatsApp® messaging channel and the SMS messaging channel only if the entity has both a WhatsApp® Enterprise account and an SMS Enterprise account with the BPS.

The bill payment system (BPS) sends 208 the first notification to the user via the selected messaging channel. If the selected messaging channel is the WhatsApp® messaging channel with fallback to short message service (SMS) messaging channel, the BPS first sends the first notification to the user using the WhatsApp® messaging channel, and if the first notification does not reach the user, then the BPS sends the first notification to the user using the SMS messaging channel. Upon the user clicking the one-click bill payment link contained in the first notification, a payment partner of the BPS sends 209 a list of payment methods to the user. Upon the payment partner of the BPS receiving the payment within a stipulated time via one or more of the payment methods, the BPS sends 210 the third notification to the user via the selected messaging channel. If the selected messaging channel is the WhatsApp® messaging channel with fallback to the SMS messaging channel, the BPS first sends the third notification to the user using the WhatsApp® messaging channel, and if the third notification does not reach the user, then the BPS sends the third notification to the user using the SMS messaging channel. Upon the payment partner of the BPS successfully receiving the payment via one or more of the payment methods, the BPS sends 214 a payment receipt information to the merchant in real time.

Upon the payment partner of the bill payment system (BPS) not receiving the payment within the stipulated time, the BPS sends 211 the second notification to the user via the selected messaging channel. If the selected messaging channel is the WhatsApp® messaging channel with fallback to short message service (SMS) messaging channel, the BPS first sends the second notification to the user using WhatsApp® messaging channel, and if the second notification does not reach the user, then the BPS sends the second notification to the user using the SMS messaging channel. Upon the user clicking the one-click bill payment link contained in the second notification, the payment partner of the BPS sends 212 a list of payment methods to the user. Upon the payment partner of the BPS receiving the payment via one or more of the payment methods, the BPS sends 213 the third notification to the user via the selected messaging channel. If the selected messaging channel is the WhatsApp® messaging channel with fallback to the SMS messaging channel, the BPS first sends the third notification to the user using the WhatsApp® messaging channel, and if the third notification does not reach the user, then the BPS sends the third notification to the user using the SMS messaging channel. Upon the payment partner of the BPS successfully receiving the payment via one or more of the payment methods, the BPS sends 214 a payment receipt information to the merchant in real time.

Upon the payment partner of the bill payment system (BPS) not receiving the payment via one or more of the payment methods within a stipulated time even after sending the first notification and the second notification, the BPS aborts the one-click bill payment transaction, and sends a notification to the merchant that the one-click bill payment transaction has been aborted due to non-payment of bill amount by the user even after sending the first notification and the second notification.

In an embodiment, the method employs a bill payment system (BPS) configured to define computer program instructions executable by at least one processor for managing payment transactions performed at the merchant locations. The BPS receives entity information and a selected messaging channel from an entity. The selected messaging channel comprise, for example, any one of a rich messaging channel, a short message service (SMS) messaging channel, and a rich messaging channel with fallback to SMS messaging channel, a rich communication services (RCS) channel, WhatsApp® messaging channel, iMessage®, Telegram®, Viber®, Signal Google Business Messages, Business Chat®, Facebook® Messenger, or any other messaging channel. The BPS sends a plurality of templates to the entity and receives a selection of three templates from the entity. The three templates comprise one of a first template, a second template, a third template, and any combination thereof. The BPS validates the three templates. The BPS receives a user identifier and payment details for a payment transaction from a merchant, and incorporates the entity information and the payment details into a first template, a second template, and a third template. The BPS generates and incorporates a one-click bill payment link into the first template and the second template. The BPS incorporates the first template into a first notification to be sent to a user device. The BPS incorporates the second template into a second notification to be sent to the user device. The BPS incorporates the third template into a third notification to be sent to the user device.

The bill payment system (BPS) sends the first notification to the user device via the selected messaging channel. If the selected messaging channel is the rich messaging channel with fallback to SMS messaging channel, the BPS first sends the first notification to the user device using the rich messaging channel, and if the first notification does not reach the user device, then the BPS sends the first notification to the user device using the SMS messaging channel. Upon the user clicking the one-click bill payment link contained in the first notification, a payment partner of the BPS sends a list of payment methods to the user device. Upon the payment partner of the BPS receiving the payment within a stipulated time via one or more of the payment methods, the BPS sends the third notification to the user device via the selected messaging channel. If the selected messaging channel is the rich messaging channel with fallback to SMS messaging channel, the BPS first sends the third notification to the user device using the rich messaging channel, and if the third notification does not reach the user device, then the BPS sends the third notification to the user device using the SMS messaging channel. Upon the payment partner of the BPS successfully receiving the payment via one or more of the payment methods, the BPS sends a payment receipt information to the merchant in real time

Upon the payment partner of the bill payment system (BPS) not receiving the payment within the stipulated time, the BPS sends the second notification to the user device via the selected messaging channel. If the selected messaging channel is the rich messaging channel with fallback to SMS messaging channel, the BPS first sends the second notification to the user device using the rich messaging channel, and if the second notification does not reach the user device, then the BPS sends the second notification to the user device using the SMS messaging channel. Upon the user clicking the one-click bill payment link contained in the second notification, the payment partner of the BPS sends the list of payment methods to the user device. Upon the payment partner of the BPS receiving the payment via one or more of the payment methods, the BPS sends the third notification to the user device via the selected messaging channel. If the selected messaging channel is the rich messaging channel with fallback to SMS messaging channel, the BPS first sends the third notification to the user device using the rich messaging channel, and if the third notification does not reach the user device, then the BPS sends the third notification to the user device using the SMS messaging channel. In an embodiment, the user device is addressed by one of a mobile number of a user or an identifier mapped to the mobile number of the user. Upon the payment partner of the BPS successfully receiving the payment via one or more of the payment methods, the BPS sends a payment receipt information to the merchant in real time

Upon the payment partner of the bill payment system (BPS) not receiving the payment via one or more of the payment methods within a stipulated time even after sending the first notification and the second notification, the BPS aborts the one-click bill payment transaction, and sends a notification to the merchant that the one-click bill payment transaction has been aborted due to non-payment of bill amount by the user even after sending the first notification and the second notification.

In an embodiment, the first notification, the second notification, and the third notification are sent to the user device via one of an alternative data messaging channel and a short message service (SMS) messaging channel in case of one of a failure of delivery and a delay in the delivery of the first notification, the second notification, the third notification to the user device. The alternative messaging channel comprise, for example, any one of a rich communication services (RCS) channel, WhatsApp® messaging channel, iMessage®, Telegram®, Viber®, Signal®, Google Business Messages, Business Chat®, Facebook® Messenger, a rich messaging channel, SMS messaging channel, and a rich messaging channel with fallback to SMS messaging channel, or any other messaging channel. In another embodiment, the first notification, the second notification, and the third notification are sent to the user device via the rich messaging channel only if the entity has a rich message channel enterprise account with the BPS. In another embodiment, the first notification, the second notification, and the third notification are sent to the user device via the short message service (SMS) messaging channel only if the entity has an SMS Enterprise account with the BPS.

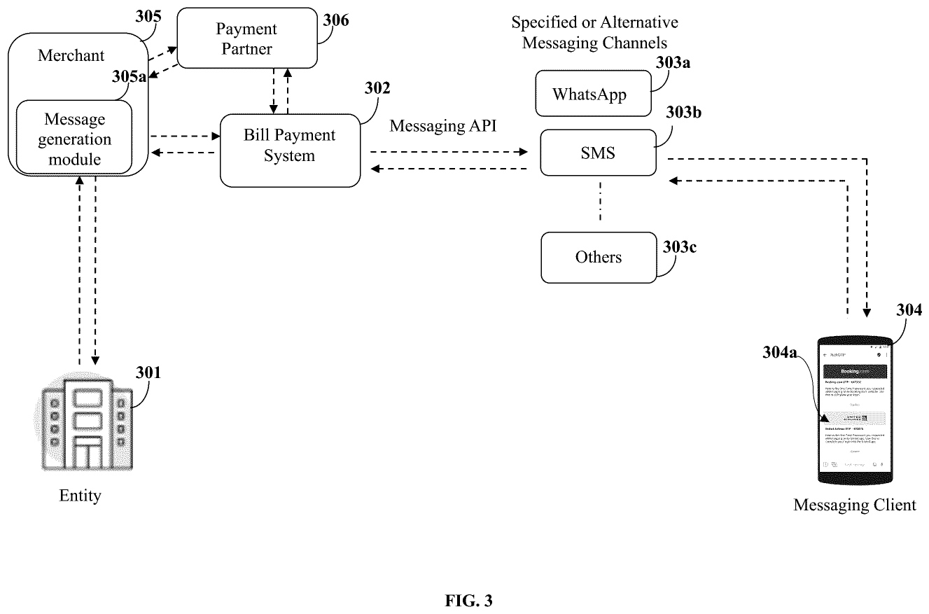

FIG. 3 exemplarily illustrates a schematic showing a process flow of an embodiment of the method for executing a one-click bill payment for a payment transaction at a merchant location, when a specified messaging channel is a WhatsApp® messaging channel and an alternative messaging channel is a short message service (SMS) messaging channel. The method employs a bill payment system (BPS) 302 for managing the payment transactions performed at the merchant locations. An entity 301 accesses the BPS 302 to create and transmit one of payment messages, payment due reminder messages, and payment request messages, with a one-click bill payment link to a mobile number of a user via the WhatsApp® messaging channel. When the entity 301 initiates a payment request event, a message generation module 305a at the merchant 305 location generates a message with the required payment information to be sent to the user's mobile number via the WhatsApp® messaging channel. The BPS 302 receives and processes the generated message to create a payment message with the one-click bill payment link. In an embodiment, the BPS 302 creates a payment message with a one-click bill payment button.

The bill payment system (BPS) 302 receives the incoming generated message and creates a request object and assigns a unique identifier (ID). The BPS 302 extracts information from the incoming generated message using multiple mechanisms, for example, template matching, natural language processing (NLP) based parameter detection, or artificial intelligence (AI) techniques to generate parameters. The BPS 302 saves the extracted information in the request object. In an embodiment, the BPS 302 further processes the incoming generated message to include calls to other third-party systems. The BPS further saves this additional data in the request object. In an embodiment, the BPS performs this further processing before the next step. In another embodiment, the BPS performs the further processing in parallel to extracting information from the incoming generated message. The BPS 302 modifies the incoming generated message to include the unique ID. In an embodiment, the BPS 302 modifies the incoming generated message to a different format depending on the parameters or message meta data. The modified message is returned.

The bill payment system (BPS) 302 incorporates a one-click bill payment link into the processed message to create the payment message. The BPS 302 sends the created payment message to the user via the WhatsApp® messaging channel. The payment message is delivered into a messaging client 304a, that is, a data messaging application, on a user device 304 associated with the user's mobile number. In an embodiment, the BPS 302 delivers the payment message to the user via the short message service (SMS) messaging channel in case of a failure of the delivery or delay in the delivery of the payment message to the user via the WhatsApp® messaging channel. Upon receiving the payment message, the user clicks the one-click bill payment link on the user device 304. Upon the user clicking the one-click bill payment link contained in the payment message, a payment partner 306 of the BPS 302 sends a list of payment methods to the user. In an embodiment, payment information is retrieved from the payment message and prefilled in a payment collection interface displayed on the user device 304. The user reviews and submits the prefilled payment information to process the payment. In another embodiment, the request object is retrieved from the payment message and optionally the BPS 302 further processes the generated incoming message to include calls to other third-party systems. The request is forwarded to the payment collection interface with additional meta data retrieved from the request object. The meta data is used to populate the fields in the payment collection interface without the user's intervention.

In another embodiment, the user needs to enter additional payment information, for example, credit card details, authorization etc., in the payment collection interface. After entering the additional information, the bill payment system (BPS) 302 instructs a payment processing module to process the payment. In another embodiment, the request object is retrieved from the payment message and optionally the BPS 302 further processes the generated incoming message to include calls to other third-party systems. A synchronous request is made to the payment processing interface with data from the request object together with additional data provided by the user. The result of this request is finally displayed on payment collection interface to the user.

Upon the payment partner of the bill payment system (BPS) 302 receiving the payment within a stipulated time via one or more of the payment methods, the BPS 302 sends a payment receipt message to the user via the WhatsApp® messaging channel. In an embodiment, the BPS 302 delivers the payment receipt message to the user via the short message service (SMS) messaging channel in case of a failure of the delivery or delay in the delivery of the payment receipt message to the user via the WhatsApp® messaging channel. The BPS 302 sends the payment receipt information to the merchant in real time.

Upon the payment partner of the bill payment system (BPS) 302 not receiving the payment within the stipulated time, the BPS 302 sends a second payment message to the user via the WhatsApp® messaging channel. In an embodiment, the BPS 302 delivers the second payment message to the user via the short message service (SMS) messaging channel in case of a failure of the delivery or delay in the delivery of the second payment message to the user via the WhatsApp® messaging channel. Upon the user clicking the one-click bill payment link contained in the second payment message, the payment partner of the BPS 302 sends the list of payment methods to the user. Upon the payment partner of the BPS 302 receiving the payment via one or more of the payment methods, the BPS 302 sends payment receipt message to the user via the WhatsApp® messaging channel. In an embodiment, the BPS 302 delivers the payment receipt message to the user via the SMS messaging channel in case of a failure of the delivery or delay in the delivery of the payment receipt message to the user via the WhatsApp® messaging channel. The BPS 302 sends payment receipt information to the merchant in real time.

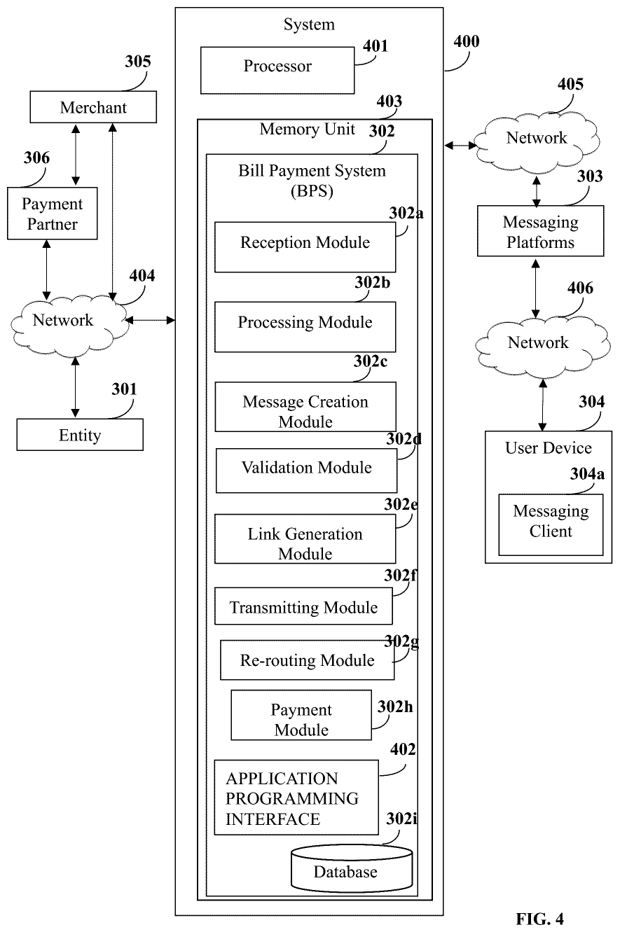

FIG. 4 exemplarily illustrates an architectural block diagram of an exemplary implementation of a system 400 for executing a one-click bill payment for a payment transaction at a merchant location. The system 400 is accessible to a merchant 305, a payment partner 306 and an entity 301, for example, a brand entity, or a developer 301 on behalf of the entity via a network 404 through a broad spectrum of technologies and devices such as personal computers with access to the internet, laptops, mobile computing devices, smart phones, tablet computing devices, servers, workstations, a portable electronic device, a network-enabled computing device, an interactive network-enabled communication device, any other suitable computing equipment, combinations of multiple pieces of computing equipment, etc. Furthermore, the system 400 communicates with multiple messaging platforms 303 that host rich messaging channels, via a network 405. The messaging platforms 303 comprise, for example, WhatsApp®, short message service (SMS), Google Business Messages (GBM), Rich Communication Services (RCS), iMessage®, Viber®, Facebook® Messenger, etc. Furthermore, the messaging platforms 303 are accessible to a user device 304 of a user via a network 406. The user device 304 is an electronic device, for example, one or more of a personal computer, a tablet computing device, a mobile computer, a mobile phone, a smartphone, a portable computing device, a laptop, a personal digital assistant, a wearable computing device such as smart glasses, a smart watch, etc., a touch centric device, a workstation, a client device, a portable electronic device, a network-enabled computing device, an interactive network-enabled communication device, an image capture device, any other suitable computing equipment, combinations of multiple pieces of computing equipment, etc.

The user device 304 comprises a messaging client 304a implemented, for example, on the Android® platform of Google Inc., the iOS platform of Apple Inc., the Windows® platform of Microsoft Corporation, or other platforms. The messaging client 304a is configured to receive messages, for example, short message service (SMS) messages, rich messages, etc., via the network 406. The messaging client 304a is, for example, the WhatsApp® instant messaging application, the iMessage® instant messaging application, the Viber® messaging application, Facebook® Messenger, etc. The networks 404, 405, and 406 that connect the system 400 to the entity 301, the messaging platforms 303, and the user device 304, respectively, are each, for example, one of the internet, satellite internet, a wireless network, a network that implements Wi-Fi® of Wi-Fi Alliance Corporation, an ultra-wideband (UWB) communication network, a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a fifth generation (5G) mobile communication network, a long-term evolution (LTE) mobile communication network, a public telephone network, etc., a local area network, a wide area network, an internet connection network, an infrared communication network, etc., or a network formed from any combination of these networks.

The system 400 disclosed herein interfaces with the devices of the entity or developer 301 on behalf of the entity and the messaging platforms 303, and in turn, with the user device 304, and in an embodiment, with one or more database systems (not shown) and servers (not shown) to implement the one-click bill payment service, and therefore more than one specifically programmed computing system is used for implementing the one-click bill payment. As exemplarily illustrated in FIG. 4, the system 400 comprises at least one processor 401, an application programming interface (API) 402 configured for one-click bill payment messages, and a non-transitory, computer-readable storage medium, for example, a memory unit 403. As used herein, “non-transitory, computer-readable storage medium” refers to all computer readable media that contain and store computer programs and data. Examples of the computer-readable media comprise hard drives, solid state drives, optical discs or magnetic disks, memory chips, a read-only memory (ROM), a register memory, a processor cache, a random-access memory (RAM), etc. The system 400 further comprises the bill payment system (BPS) 302 configured to define computer program instructions executable by at least one processor 401. The non-transitory, computer-readable storage medium, herein exemplarily referred to as the memory unit 403, is configured to store the computer program instructions defined by the BPS 302. In an embodiment, the memory unit 403 stores the modules 302a, 302b, 302c, 302d, 302e, 302f, 302g, 302h, and 302i of the BPS 302 as exemplarily illustrated in FIG. 4.

The processor 401 is operably and communicatively coupled to the memory unit 403 for executing the computer program instructions defined by the modules, for example, 302a, 302b, 302c, 302d, 302e, 302f, 302g, 302h, and 302i of the bill payment system (BPS) 302. The memory unit 403 is a storage unit used for recording, storing, and reproducing data, program instructions, and applications. In an embodiment, the memory unit 403 comprises a random-access memory (RAM) or another type of dynamic storage device that serves as a read and write internal memory and provides short-term or temporary storage for information and instructions executable by the processor 401. The memory unit 403 also stores temporary variables and other intermediate information used during execution of the instructions by the processor 401. In another embodiment, the memory unit 403 further comprises a read-only memory (ROM) or another type of static storage device that stores firmware, static information, and instructions for execution by the processor 401. The modules, for example, 302a, 302b, 302c, 302d, 302e, 302f, 302g, 302h, and 302i of the BPS 302, when loaded into the memory unit 403 and executed by the processor 401, transform the system 400 into a specially-programmed, special purpose computing device configured to implement the functionality disclosed herein. The processor 401 refers to one or more microprocessors, central processing unit (CPU) devices, finite state machines, computers, microcontrollers, digital signal processors, logic, a logic device, an application specific integrated circuit (ASIC), a field-programmable gate array (FPGA), a chip, etc., or any combination thereof, capable of executing computer programs or a series of commands, instructions, or state transitions. In an embodiment, the processor 401 is implemented as a processor set comprising, for example, a programmed microprocessor and a math or graphics co-processor. The BPS 302 is not limited to employing the processor 401. In an embodiment, the BPS 302 employs a controller or a microcontroller.

The bill payment system (BPS) 302 defines computer program instructions, which when executed by the processor 401, causes the processor 401 to manage actions associated with executing a one-click bill payment for a payment transaction at a merchant location. In the exemplary implementation of the system 400 illustrated in FIG. 4, the BPS 302 comprises a reception module 302a, a processing module 302b, a message creation module 302c, a validation module 302d, a link generation module 302e, a transmitting module 202f, a re-routing module 302g, a payment module 302h, and a database 302i. The reception module 302a receives a request to send a payment request message from an entity 301 or a developer on behalf of the entity 301 to a mobile number of a user. In an embodiment, the application programming interface (API) 402 receives a request to send a payment request message from an entity or a developer 301 on behalf of the entity to the mobile number of the user. The reception module 302a receives the request from the API 602 and passes the request to the processing module 302b.

The processing module 302b is configured to process the request to send a payment request message from an entity 301 or a developer on behalf of the entity 301 to a mobile number of a user. The reception module 302a is further configured to receive entity information and a selected messaging channel from the entity 301. The selected messaging channel is one of a WhatsApp® messaging channel, a short message service (SMS) messaging channel, and a WhatsApp® messaging channel with fallback to SMS messaging channel. In an embodiment, the selected messaging channel is any one of an rich communication service (RCS) channel, an instant messaging channel, a business messaging channel, and a social media messaging channel as disclosed in the description of FIGS. 2A-2B. The message creation module 302c sends multiple templates to the entity and receives a selection of three templates from the entity 301. The three templates comprise one of a first template, a second template, a third template, and any combination thereof. In an embodiment, the database 302i stores the multiple templates and the selected templates. The database 302i is any storage area or medium that can be used for storing the multiple templates and the selected templates. In an embodiment, the database 302i is any of a structured query language (SQL) database or a not only SQL (NoSQL) database. In another embodiment, the database 302i is a location on a file system. In another embodiment, the database 302i is configured to be remotely accessible by the bill payment system (BPS) 302 in the system 400 via the network 405. In another embodiment, the database 302i is configured as a cloud-based database implemented in a cloud computing environment.

The validation module 302d validates the three templates. The message creation module 302c receives a user identifier and payment details for a payment transaction from a merchant 305, and incorporates the received entity information and the payment details into the first template, the second template, and the third template;

The link generation module 302e generates and incorporates a one-click bill payment link into the first template and the second template. The message creation module 302c incorporates the first template into a first notification to be sent to the user. The message creation module 302c incorporates the second template into a second notification to be sent to the user. The message creation module 302c incorporates the third template into a third notification to be sent to the user. In an embodiment, the database 302i stores the first template, the second template, the third template, the first notification, the second notification, and the third notification.

The transmitting module 302f sends the first notification to the user via the selected messaging channel. The transmitting module 302f delivers the first notification into a default messaging application, that is, the messaging client 304a deployed on the user device 304 with a subscriber identity module (SIM) that represents the user's mobile number. In an embodiment, the transmitting module 302f delivers the first notification into a data messaging application on the user device 304 that is registered to the user's mobile number. If the selected messaging channel is the WhatsApp® messaging channel with fallback to the SMS messaging channel, the transmitting module 302f first sends the first notification to the user using the WhatsApp® messaging channel, and if the first notification does not reach the user, then the re-routing module 302g sends the first notification to the user using the SMS messaging channel. In an embodiment, the transmitting module 302f delivers the first notification from a verified sender identifier (ID) or from a sender ID generated by an entity that is sending the first notification. In another embodiment, a service provider verifies the identity of the entity 301, for example, a brand identity, included in the first notification.

The messaging client 304a on the user device 304 associated with the user's mobile number receives the transmitted first notification. Upon the user clicking the one-click bill payment link contained in the first notification, the payment module 302h sends a list of payment methods to the user. A payment partner 306 of the bill payment system 302 provides the list of payment methods. The user selects a payment method from the list of payment methods to make the payment. Upon the payment partner 306 of the bill payment system 302 receiving the payment within the stipulated time via one or more of the payment methods, the transmitting module 302f sends the third notification to the user via the selected messaging channel. If the selected messaging channel is the WhatsApp® messaging channel with fallback to SMS messaging channel, the transmitting module 302f first sends the third notification to the user using the WhatsApp® messaging channel, and if the third notification does not reach the user, then the re-routing module 302g sends the third notification to the user using the SMS messaging channel. Upon the payment partner 306 of the BPS 302 successfully receiving the payment via one or more of the payment methods, the payment module 302h sends a payment receipt information to the merchant 305 in real time.

Upon the payment partner 306 of the bill payment system 302 not receiving the payment within the stipulated time, the transmitting module 302f sends the second notification to the user via the selected messaging channel. If the selected messaging channel is the WhatsApp® messaging channel with fallback to SMS messaging channel, the transmitting module 302f first sends the second notification to the user using the WhatsApp® messaging channel, and if the second notification does not reach the user, then the re-routing module 302g sends the second notification to the user using the SMS messaging channel. Upon the user clicking the one-click bill payment link contained in the second notification, the payment module 302h sends a list of payment methods to the user. The user selects a payment method from the list of payment methods to make the payment. Upon the payment partner 306 of the bill payment partner 302 receiving the payment via one or more of the payment methods, the transmitting module 302f sends the third notification to the user via the selected messaging channel. If the selected messaging channel is the WhatsApp® messaging channel with fallback to SMS messaging channel, the transmitting module 302f first sends the third notification to the user using the Whats App® messaging channel, and if the third notification does not reach the user, then the re-routing module 302g sends the third notification to the user using the SMS messaging channel. Upon the payment partner 306 of the BPS 302 successfully receiving the payment via one or more of the payment methods, the payment module 302h sends payment receipt information to the merchant 305 in real time. If the payment partner 306 of the BPS 302 does not receive the payment via one or more of the payment methods within a stipulated time even after sending the first notification and the second notification, the BPS 302 aborts the one-click bill payment transaction, and a notification is sent to the merchant 305 that the one-click bill payment transaction has been aborted due to non-payment of bill amount by the user even after sending the first notification and the second notification.

The processor 401 of the system 400 disclosed herein retrieves instructions defined by the reception module 302a, the processing module 302b, the message creation module 302c, the validation module 302d, the link generation module 302e, the transmitting module 302f, the re-routing module 302g, the payment module 302h, etc., from the memory unit 403 for executing their respective functions disclosed above. The modules 302a, 302b, 302c, 302d, 302e, 302f, 302g, and 302h of the bill payment system (BPS) 302 are disclosed above as software executed by the processor 401. In an embodiment, the modules 302a, 302b, 302c, 302d, 302e, 302f, 302g, and 302h of the BPS 302 are implemented completely in hardware. In another embodiment, the modules 302a, 302b, 302c, 302d, 302e, 302f, 302g, and 302h of the BPS 302 are implemented by logic circuits to carry out their respective functions disclosed above. In another embodiment, the system 400 is also implemented as a combination of hardware and software including the application programming interface (API) 402 and one or more processors, for example, 401, that are used to implement the modules, for example, 302a, 302b, 302c, 302d, 302e, 302f, 302g, and 302h of the BPS 302.

For purposes of illustration, the disclosure herein refers to the modules 302a, 302b, 302c, 302d, 302e, 302f, 302g, and 302h of the bill payment system (BPS) 302 being run locally on a single computer system 400; however the scope of the BPS 302 and the method disclosed herein is not limited to the modules 302a, 302b, 302c, 302d, 302e, 302f, 302g, and 302h being run locally on a single computer system 400 via an operating system and the processor 401, but extends to running the modules 302a, 302b, 302c, 302d, 302e, 302f, 302g, and 302h remotely over the network 405 by employing a web browser and a remote server, a mobile phone, or other electronic devices. In an embodiment, one or more portions of the system 400 disclosed herein are distributed across one or more computer systems (not shown) coupled to the network 405.

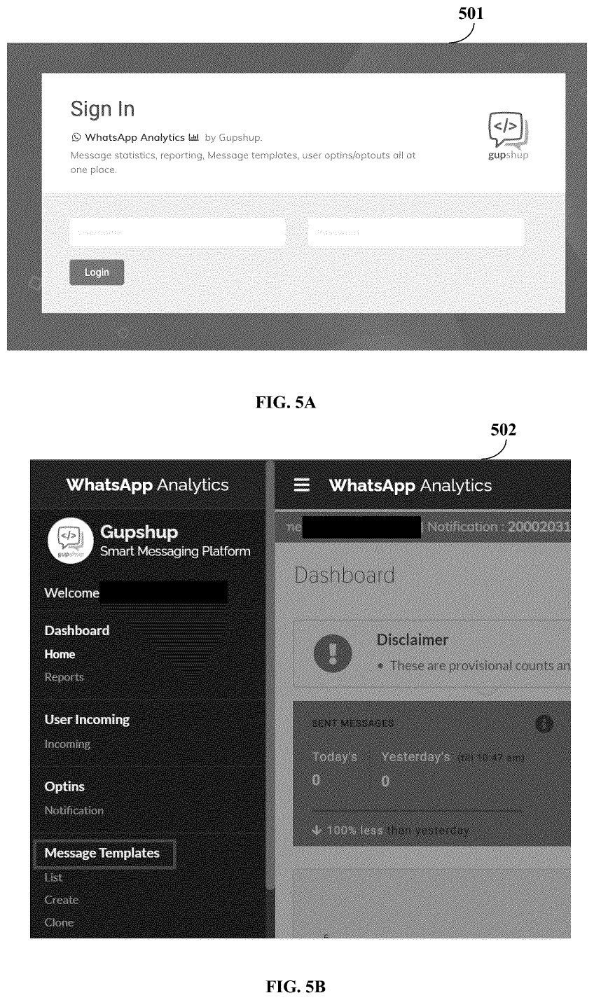

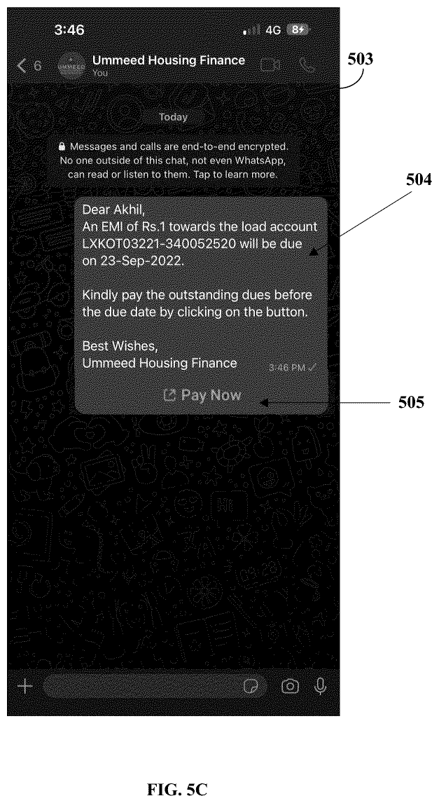

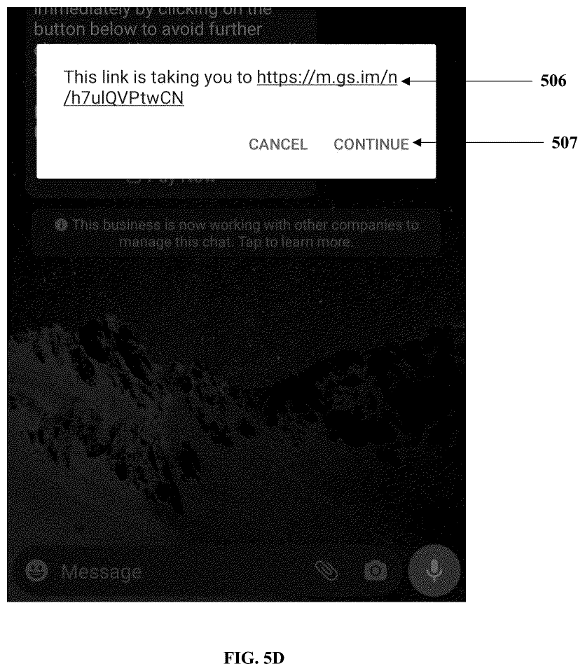

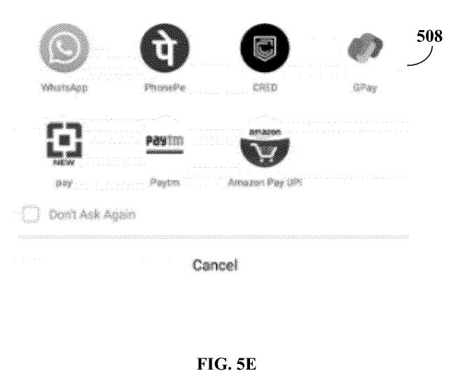

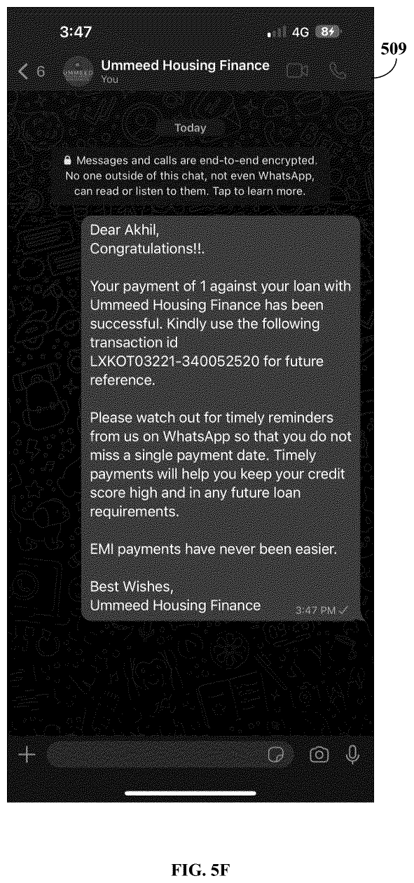

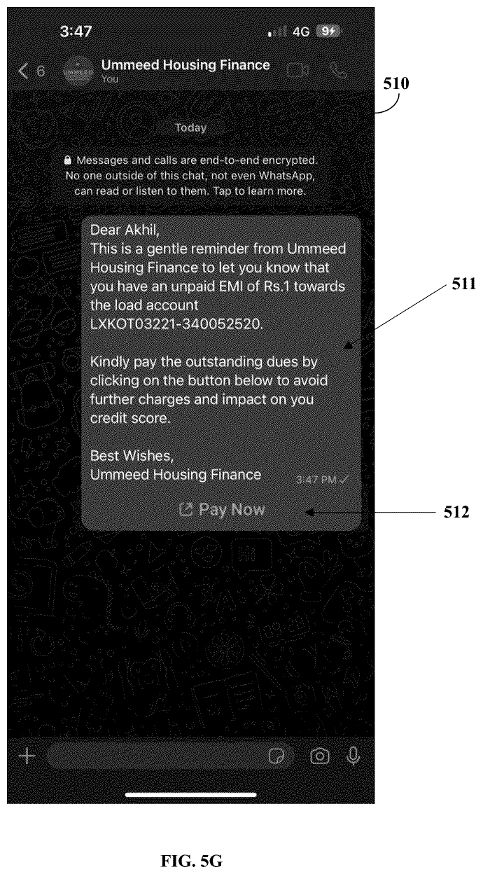

Consider an example where an entity wants to create and transmit one of payment messages, payment due reminder messages, and payment request messages, with a one-click bill payment link to a mobile number of a user via the WhatsApp® messaging channel. The entity will sign in to a bill payment system (BPS) by entering their “username” and “password” on a login interface 501, as exemplarily illustrated in FIG. 5A. After signing in, the BPS displays a user interface 502 comprising multiple tabs, for example, dashboard, home, reports, user incoming, incoming, optins, notification, message templates, etc., to the entity. On receiving a request to send a payment notification with one-click bill payment from the entity, the BPS initiates an application programming interface (API) call, as shown below, to receive entity information and a selection of messaging channel from the entity. In an embodiment, a payment notification may also be a payment message or vice versa.

GET/lcbp/templates/list?channel=whatsapp&login=xxxxx&pwd=yyyyy
The entity is denoted by the login (xxxxx) and channel is WhatsApp® messaging channel.

The bill payment system sends multiple templates to the entity. The API call response is shown below:

```
{
  “response”: “success”,
  “payload”: [{
    “id”: “xxxx1”,
    “name”: “first template”,
    “template”: “Dear { {name} },\nAn EMI of Rs. { {amount} } towards the load account
{ {accno} } will be due on { {date} }.\n\nKindly pay the outstanding dues before the due
date by clicking on the button. \n\nBest Wishes,\nUmmeed Housing Finance”,
    ...
  },{
    “id”: “xxxx2”,
    “name”: “second template”,
    “template”: “Dear { {name} },\nThis is a gentle reminder from Ummeed Housing
Finance to let you know that you have an unpaid EMI of Rs.{ {amount} } towards the load
account { {accno} }.\n\nKindly pay the outstanding dues by clicking on the button below
to avoid further charges and impact on you credit score.\n\nBest Wishes, \nUmmeed
Housing Finance”,
    ...
  },{
    “id”: “xxxx3”,
    “name”: “third template”,
    “template”: “Dear { {name} },\nCongratulations !!.\n\Your payment of
Rs.{ {amount} } against your loan with Ummeed Housing Finance has been successful.
Kindly use the following transaction id { {transid} } for future reference.\n\nPlease watch
out for timely reminders from us on WhatsApp so that you do not miss a single payment
date. Timely payments will help you keep your credit score high and in any future loan
requirements.\n\nEMI payments have never been easier.\n\nBest Wishes, \nUmmeed
Housing Finance”,
    ...
  },
  ...
  ]
}
```

The response contains a JavaScript Object Notation (JSON) object which has a JSON array called payload. Each item in this array denotes a template.

The bill payment system receives a selection of three templates, as shown below:

POST /1cbp/createBillPayment?template1=xxxx1 &template2=xxxx2
&template3=xxxx3 &login=xxxxx &pwd-yyyyy

On receiving the application programming interface (API) request, the bill payment system verifies the three templates, and on success, returns a success response as shown below:

### API Call Response

| | |
|---|---|
| { | |
| | “response”: “success”, |
| | “id”: “yyyy1” |
| } | |

The bill payment system receives a user identifier and payment details for a payment transaction from a merchant, as shown below:

POST /1cbp/initiatePaymentMessage?id=yyyy1 &login=xxxxx &pwd-yyyyy
&name=Akhil &amount=1 &accno-LXKOT03221-340052520 &transid=
LXKOT03221-340052520 &date-23-Sep-2022

The bill payment system incorporates the entity information, the user identifier, and the payment details into the three templates to create three notifications as follows:

### Notification 1

### Dear Akhil,

An EMI of Rs.1 towards the load account DCKOT03221-340052520 will be due on 23 Sep. 2022.
Kindly pay the outstanding dues before the due date by clicking on the button.

### Best Wishes,

### Ummeed Housing Finance

### Notification 2

### Dear Akhil,

This is a gentle reminder from Ummeed Housing Finance to let you know that you have an unpaid EMI of Rs.1 towards the load account DCKOT03221-340052520.
Kindly pay the outstanding dues by clicking on the button below to avoid further charges and impact on you credit score.

### Best Wishes,

### Ummeed Housing Finance

### Notification 3

### Dear Akhil,

### Congratulations!!.

Your payment of Rs.1 against your loan with Ummeed Housing Finance has been successful. Kindly use the following transaction id LXKOT03221-340052520 for future reference.
Please watch out for timely reminders from us on WhatsApp so that you do not miss a single payment date. Timely payments will help you keep your credit score high and in any future loan requirements.
EMI payments have never been easier.

### Best Wishes,

### Ummeed Housing Finance

The bill payment system generates one-click bill payment link by calling third party APIs

POST /paymentgateway/link?amount-1 &referenceid= LXKOT03221-340052520
&account=aaaaa &pwd=bbbbb

### Response

| | |
|---|---|
| { | |
| | “response”: “success”, |
| | “link”: “https://m.gs.in/m/h7ulQVPtwCN” |
| } | |

The bill payment system incorporates the one-click bill payment link into the first template and the second template.

Generate JSON Object with button and link as follows—

### Notification 1:

```
{
  “type”: “message”,
  “text”: “Dear Akhil,\nAn EMI of Rs.1 towards the load account LXKOT03221-
340052520 will be due on 23-Sep-2022.\n\nKindly pay the outstanding dues before the
due date by clicking on the button.\n\nBest Wishes,\nUmmeed Housing Finance”,
  “buttonlink”: “https://m.gs.in/m/h7ulQVPtwCN”,
  “buttontext”: “Pay Now”
}
```

### Notification 2:

```
{
  “type”: “message”,
  “text”: “Dear Akhil,\nThis is a gentle reminder from Ummeed Housing Finance to let
you know that you have an unpaid EMI of Rs.1 towards the load account LXKOT03221-
340052520.\n\nKindly pay the outstanding dues by clicking on the button below to avoid
further charges and impact on you credit score.\n\nBest Wishes,\nUmmeed Housing
Finance”,
  “buttonlink”: “https://m.gs.in/m/h7ulQVPtwCN”,
  “buttontext”: “Pay Now”
}
```

The BPS sends the first notification to the user via API call to the WhatsApp messaging channel

POST /whatsapp/msg?from=nnnnn &payload={ “type”: “message”, “text”: “Dear
Akhil,\nAn EMI of Rs.1 towards the load account LXKOT03221-340052520 will be due
on 23-Sep-2022.\n\nKindly pay the outstanding dues before the due date by clicking on
the button.\n\nBest Wishes,\nUmmeed Housing Finance”, “buttonlink”:
“https://m.gs.in/m/h7ulQVPtwCN”, “buttontext”: “Pay Now”}

FIG. 5C exemplarily illustrates a screen shot of the first notification 503 sent to the user. The first notification 503 comprises a text message 504 and one-click payment link 505.

Upon the user clicking the one-click payment link 505 in the first notification 503, a notification “This link is taking you to the https://m.gs.im/n/h7ulQVPtwCN” 506 is displayed on the user interface as exemplarily illustrated in FIG. 5D. Upon the user clicking the option continue 507, the payment partner of the BPS sends a list of payments methods 508 to the user as exemplarily illustrated in FIG. 5E.

Upon the payment partner of the bill payment system (BPS) receiving the payment within a stipulated time via one or more of the payment methods, the BPS sends the third notification to the user. FIG. 5F exemplarily illustrates the third notification 509 sent to the user.

POST /whatsapp/msg?from=nnnnn &payload={ “type”: “message”, “text”: “Dear
Akhil,\nCongratulations!!.\n\n Your payment of Rs. 1 against your loan with Ummeed
Housing Finance has been successful. Kindly use the following transaction id
LXKOT03221-340052520 for future reference. \n\nPlease watch out for timely reminders
from us on WhatsApp so that you do not miss a single payment date. Timely payments
will help you keep your credit score high and in any future loan requirements.\n\nEMI
payments have never been easier.\n\nBest Wishes, \nUmmeed Housing Finance”}

Upon the payment partner of the bill payment system (BPS) not receiving the payment within the stipulated time, the BPS sends the second notification to the user. FIG. 5G exemplarily illustrates the second notification 510 sent to the user. The second notification 510 comprises a text message 511 and one-click payment link 512.

POST /whatsapp/msg?from=nnnnn &payload={ “type”: “message”, “text”: “Dear
Akhil, InThis is a gentle reminder from Ummeed Housing Finance to let you know that
you have an unpaid EMI of Rs. 1 towards the load account LXKOT03221-
340052520.\n\nKindly pay the outstanding dues by clicking on the button below to avoid
further charges and impact on you credit score. \n\nBest Wishes, \nUmmeed Housing
Finance”, “buttonlink”: “https://m.gs.in/m/h7ulQVPtwCN”, “buttontext”: “Pay Now” }

Upon the user clicking the one-click payment link 512 in the second notification 510, a notification “This link is taking you to the https://m.gs.im/n/h7ulQVPtwCN” 506 is displayed on the user interface as exemplarily illustrated in FIG. 5D. Upon the user clicking the option continue 507, the payment partner of the BPS sends the list of payments methods 508 to the user as exemplarily illustrated in FIG. 5E.

Upon the payment partner of the bill payment system (BPS) receiving the payment within a stipulated time via one or more of the payment methods, the BPS sends the third notification to the user. FIG. 5F exemplarily illustrates the third notification 509 sent to the user.

POST /whatsapp/msg?from=nnnnn &payload={ “type”: “message”, “text”: “Dear
Akhil,\nCongratulations !!.\n\n Your payment of Rs.1 against your loan with Ummeed
Housing Finance has been successful. Kindly use the following transaction id
LXKOT03221-340052520 for future reference.\n\nPlease watch out for timely reminders
from us on WhatsApp so that you do not miss a single payment date. Timely payments
will help you keep your credit score high and in any future loan requirements.\n\nEMI
payments have never been easier.\n\nBest Wishes,\nUmmeed Housing Finance”}

Upon the payment partner of the bill payment system (BPS) successfully receiving the payment via one or more of the payment methods, the BPS sends a payment receipt information to the merchant in real time.

Make API call
/ummeed/callback? &referenceid= LXKOT03221-340052520 &status=success

The non-transitory, computer-readable storage medium, herein exemplarily referred to as the memory unit 403, stores computer program instructions of a bill payment system (BPS) 302 executable by at least one processor 401 for executing a one-click bill payment for a payment transaction at a merchant location. The computer program instructions when executed by the processor 401 cause the processor to: receive entity information and a selected messaging channel from an entity, wherein the selected messaging channel is one of a WhatsApp messaging channel, a short message service (SMS) messaging channel, and a WhatsApp messaging channel with fallback to SMS messaging channel; send a plurality of templates to the entity and receiving a selection of three templates from the entity, wherein the three templates comprise one of a first template, a second template, a third template, and any combination thereof; validate the three templates; receive a user identifier and payment details for a payment transaction from a merchant, and incorporating the entity information and the payment details into the first template, the second template, and the third template; generate and incorporate a one-click bill payment link into the first template and the second template, wherein the first template is incorporated into a first notification to be sent to the user, and wherein the second template is incorporated into a second notification to be sent to the user; incorporate the third template into a third notification to be sent to the user; send the first notification to the user via the selected messaging channel, wherein if the selected messaging channel is the WhatsApp messaging channel with fallback to SMS messaging channel, the first notification is first sent to the user using the WhatsApp messaging channel, and if the first notification does not reach the user, then the first notification is sent to the user using the SMS messaging channel; upon the user clicking the one-click bill payment link contained in the first notification, send a list of payment methods to the user, by a payment partner of the bill payment system; upon the payment partner of the bill payment system receiving the payment within a stipulated time via one or more of the payment methods, send the third notification to the user via the selected messaging channel, wherein if the selected messaging channel is the WhatsApp messaging channel with fallback to SMS messaging channel, the third notification is first sent to the user using the WhatsApp messaging channel, and if the third notification does not reach the user, then the third notification is sent to the user using the SMS messaging channel; upon the payment partner of the bill payment system not receiving the payment within the stipulated time, send the second notification to the user via the selected messaging channel, wherein if the selected messaging channel is the WhatsApp with fallback to SMS messaging channel, the second notification is first sent to the user using the WhatsApp messaging channel, and if the second notification does not reach the user, then the second notification is sent to the user using the SMS messaging channel; upon the user clicking the one-click bill payment link contained in the second notification, send the list of payment methods to the user, by the payment partner of the bill payment system; upon the payment partner of the bill payment partner receiving the payment via one or more of the payment methods, send the third notification to the user via the selected messaging channel, wherein if the selected messaging channel is the WhatsApp messaging channel with fallback to SMS messaging channel, the third notification is first sent to the user using the WhatsApp messaging channel, and if the third notification does not reach the user, then the third notification is sent to the user using the SMS messaging channel; and upon the payment partner of the bill payment system successfully receiving the payment via one or more of the payment methods, send a payment receipt information to the merchant in real time. If the payment partner of the bill payment system does not receive the payment via one or more of the payment methods within a stipulated time even after sending the first notification and the second notification, the one-click bill payment transaction is aborted, and notification is sent to the merchant that the one-click bill payment transaction has been aborted due to non-payment of bill amount by the user even after sending the first notification and the second notification.

The computer program instructions disclosed above implement the processes of various embodiments disclosed above and perform additional steps that may be required and contemplated for executing a one-click bill payment for a payment transaction at a merchant location. When the computer program instructions are executed by the processor(s) 401, the computer program instructions cause the processor(s) 401 to perform the steps of the method for creating and transmitting a rich message as disclosed in the descriptions of FIGS. 2A-2B. In an embodiment, a single piece of computer program code comprising computer program instructions performs one or more steps of the method disclosed in the descriptions of FIGS. 2A-2B. The processor(s) 401 retrieves these computer program instructions and executes them.

A module, or an engine, or a unit, as used herein, refers to any combination of hardware, software, and/or firmware. As an example, a module, or an engine, or a unit includes hardware such as a microcontroller, associated with a non-transitory, computer-readable storage medium to store computer program codes adapted to be executed by the microcontroller. Therefore, references to a module, or an engine, or a unit, in an embodiment, refer to the hardware that is specifically configured to recognize and/or execute the computer program codes to be held on a non-transitory, computer-readable storage medium. In an embodiment, the computer program codes comprising computer readable and executable instructions are implemented in any programming language, for example, C, C++, C #, Java®, JavaScript®, Fortran, Ruby, Perl®, Python®, Visual Basic®, hypertext pre-processor (PHP), Microsoft® .NET, Objective-C®, the Swift™ programming language of Apple Inc., etc. In another embodiment, other object-oriented, functional, scripting, and/or logical programming languages are also used. In an embodiment, the computer program codes or software programs are stored on or in one or more mediums as object code. In another embodiment, the term “module” or “engine” or “unit” refers to the combination of the microcontroller and the non-transitory, computer-readable storage medium. Often module or engine or unit boundaries that are illustrated as separate commonly vary and potentially overlap. For example, a module or an engine or a unit may share hardware, software, firmware, or a combination thereof, while potentially retaining some independent hardware, software, or firmware. In various embodiments, a module or an engine or a unit includes any suitable logic.

It is apparent in different embodiments that the various methods, algorithms, and computer-readable programs disclosed herein are implemented on non-transitory, computer-readable storage media appropriately programmed for computing devices. The non-transitory, computer-readable storage media participate in providing data, for example, instructions that are read by a computer, a processor, or a similar device. In different embodiments, the “non-transitory, computer-readable storage media” also refer to a single medium or multiple media, for example, a centralized database, a distributed database, and/or associated caches and servers that store one or more sets of instructions that are read by a computer, a processor, or a similar device. The “non-transitory, computer-readable storage media” also refer to any medium capable of storing or encoding a set of instructions for execution by a computer, a processor, or a similar device and that causes a computer, a processor, or a similar device to perform any one or more of the steps of the method disclosed herein. In an embodiment, the computer programs that implement the method and algorithms disclosed herein are stored and transmitted using a variety of media, for example, the computer-readable media in various manners. In an embodiment, hard-wired circuitry or custom hardware is used in place of, or in combination with, software instructions for implementing the processes of various embodiments. Therefore, the embodiments are not limited to any specific combination of hardware and software. Various aspects of the embodiments disclosed herein are implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the embodiments disclosed herein are implemented as programmed elements, or non-programmed elements, or any suitable combination thereof.

Where databases are described such as the database 302i exemplarily illustrated in FIG. 4, it will be understood by one of ordinary skill in the art that (i) alternative database structures to those described may be employed, and (ii) other memory structures besides databases may be employed. Any illustrations or descriptions of any sample databases disclosed herein are illustrative arrangements for stored representations of information. In an embodiment, any number of other arrangements are employed besides those suggested by tables illustrated in the drawings or elsewhere. In another embodiment, despite any depiction of the databases as tables, other formats including relational databases, object-based models, and/or distributed databases are used to store and manipulate the data types disclosed herein. In an embodiment, object methods or behaviors of a database are used to implement various processes such as those disclosed herein. In another embodiment, the databases are, in a known manner, stored locally or remotely from a device that accesses data in such a database. In embodiments where there are multiple databases, the databases are integrated to communicate with each other for enabling simultaneous updates of data linked across the databases, when there are any updates to the data in one of the databases.

The embodiments disclosed herein are configured to operate in a network environment comprising one or more computers that are in communication with one or more devices via one or more networks. In an embodiment, the computers communicate with the devices directly or indirectly, via a wired medium or a wireless medium such as the Internet, satellite internet, a local area network (LAN), a wide area network (WAN) or the Ethernet, or via any appropriate communications mediums or combination of communications mediums. Each of the devices comprises processors that are adapted to communicate with the computers. In an embodiment, each of the computers is equipped with a network communication device, for example, a network interface card, a modem, or other network connection device suitable for connecting to a network. Each of the computers and the devices executes an operating system. While the operating system may differ depending on the type of computer, the operating system provides the appropriate communications protocols to establish communication links with the network. Any number and type of machines may be in communication with the computers.

The embodiments disclosed herein are not limited to a particular computer system platform, processor, operating system, or network. One or more of the embodiments disclosed herein are distributed among one or more computer systems, for example, servers configured to provide one or more services to one or more client computers, or to perform a complete task in a distributed system. For example, one or more of embodiments disclosed herein are performed on a client-server system that comprises components distributed among one or more server systems that perform multiple functions according to various embodiments. These components comprise, for example, executable, intermediate, or interpreted code, which communicate over a network using a communication protocol. The embodiments disclosed herein are not limited to be executable on any particular system or group of systems, and are not limited to any particular distributed architecture, network, or communication protocol.

The foregoing examples and illustrative implementations of various embodiments have been provided merely for explanation and are in no way to be construed as limiting of the embodiments disclosed herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments herein are not intended to be limited to the particulars disclosed herein; rather, the embodiments herein extend to all functionally equivalent structures, methods, systems, and uses, such as are within the scope of the appended claims. It will be understood by those skilled in the art, having the benefit of the teachings of this specification, that the embodiments disclosed herein are capable of modifications and other embodiments may be effected and changes may be made thereto, without departing from the scope and spirit of the embodiments disclosed herein.

We claim:

1. A method employing a bill payment system configured to define computer program instructions executable by at least one processor for executing a one-click bill payment for a payment transaction at a merchant location, the method comprising:
receiving entity information and a selected messaging channel from an entity, wherein the selected messaging channel is one of a WhatsApp messaging channel, a short message service (SMS) messaging channel, and a WhatsApp messaging channel with fallback to SMS messaging channel;
sending a plurality of templates to the entity and receiving a selection of three templates from the entity, wherein the three templates comprise one of a first template, a second template, a third template, and any combination thereof;
validating the three templates;
receiving a user identifier and payment details for a payment transaction from a merchant, and incorporating the entity information and the payment details into the first template, the second template, and the third template;
generating and incorporating a one-click bill payment link into the first template and the second template, wherein the first template is incorporated into a first notification to be sent to a user, and wherein the second template is incorporated into a second notification to be sent to the user;
incorporating the third template into a third notification to be sent to the user;
sending the first notification to the user via the selected messaging channel, wherein if the selected messaging channel is the WhatsApp messaging channel with fallback to SMS messaging channel, the first notification is first sent to the user using the WhatsApp messaging channel, and if the first notification does not reach the user, then the first notification is sent to the user using the SMS messaging channel;
upon the user clicking the one-click bill payment link contained in the first notification, sending a list of payment methods to the user;
upon a payment partner of the bill payment system receiving the payment within a stipulated time via one or more of the payment methods, sending the third notification to the user via the selected messaging channel, wherein if the selected messaging channel is the WhatsApp messaging channel with fallback to SMS messaging channel, the third notification is first sent to the user using the WhatsApp messaging channel, and if the third notification does not reach the user, then the third notification is sent to the user using the SMS messaging channel;
upon the payment partner of the bill payment system not receiving the payment within the stipulated time, sending the second notification to the user via the selected messaging channel, wherein if the selected messaging channel is the WhatsApp messaging channel with fallback to SMS messaging channel, the second notification is first sent to the user using the WhatsApp messaging channel, and if the second notification does not reach the user, then the second notification is sent to the user using the SMS messaging channel;
upon the user clicking the one-click bill payment link contained in the second notification, sending the list of payment methods to the user;
upon the payment partner of the bill payment system receiving the payment via one or more of the payment methods, sending the third notification to the user via the selected messaging channel, wherein if the selected messaging channel is the WhatsApp messaging channel with fallback to SMS messaging channel, the third notification is first sent to the user using the WhatsApp messaging channel, and if the third notification does not reach the user, then the third notification is sent to the user using the SMS messaging channel; and
upon the payment partner of the bill payment system successfully receiving the payment via one or more of the payment methods, sending a payment receipt information to the merchant in real time.

2. The method of claim 1, further comprising: upon the payment partner of the bill payment portal not receiving the payment via one or more of the payment methods even after sending the first notification and the second notification aborting the one-click bill payment transaction, and sending a notification to the merchant that the one-click bill payment transaction has been aborted due to non-payment of bill amount by the user even after sending the first notification and the second notification.

3. The method of claim 1, wherein the first notification, the second notification, and the third notification are sent to the user via the WhatsApp messaging channel only if the entity has a WhatsApp Enterprise account with the bill payment system.

4. The method of claim 1, wherein the first notification, the second notification, and the third notification are sent to the user via the short message service (SMS) messaging channel only if the entity has an SMS Enterprise account with the bill payment system.

5. A method employing a bill payment system configured to define computer program instructions executable by at least one processor for executing a one-click bill payment for a payment transaction at a merchant location, the method comprising:
receiving entity information and a selected messaging channel from an entity, wherein the selected messaging channel is one of a rich messaging channel, a short message service (SMS) messaging channel, and a rich messaging channel with fallback to SMS messaging channel;
sending a plurality of templates to the entity and receiving a selection of three templates from the entity, wherein the three templates comprise one of a first template, a second template, a third template, and any combination thereof;
validating the three templates;
receiving a user identifier and payment details for a payment transaction from a merchant, and incorporating the entity information and the payment details into the first template, the second template, and the third template;
generating and incorporating a one-click bill payment link into the first template and the second template, wherein the first template is incorporated into a first notification to be sent to a user device, and wherein the second template is incorporated into a second notification to be sent to the user device;
incorporating the third template into a third notification to be sent to the user device;
sending the first notification to the user device via the selected messaging channel, wherein if the selected messaging channel is the rich messaging channel with fallback to SMS messaging channel, the first notification is first sent to the user device using the rich messaging channel, and if the first notification does not reach the user device, then the first notification is sent to the user device using the SMS messaging channel;
upon a user clicking the one-click bill payment link contained in the first notification, sending a list of payment methods to the user device;
upon a payment partner of the bill payment system receiving the payment within a stipulated time via one or more of the payment methods, sending the third notification to the user device via the selected messaging channel, wherein if the selected messaging channel is the rich messaging channel with fallback to SMS messaging channel, the third notification is first sent to the user device using the rich messaging channel, and if the third notification does not reach the user device, then the third notification is sent to the user device using the SMS messaging channel;
upon the payment partner of the bill payment system not receiving the payment within the stipulated time, sending the second notification to the user device via the selected messaging channel, wherein if the selected messaging channel is the rich messaging channel with fallback to SMS messaging channel, the second notification is first sent to the user device using the rich messaging channel, and if the second notification does not reach the user device, then the second notification is sent to the user device using the SMS messaging channel;
upon the user clicking the one-click bill payment link contained in the second notification, sending the list of payment methods to the user device;
upon the payment partner of the bill payment system receiving the payment via one or more of the payment methods, sending the third notification to the user device via the selected messaging channel, wherein if the selected messaging channel is the rich messaging channel with fallback to SMS messaging channel, the third notification is first sent to the user device using the rich messaging channel, and if the third notification does not reach the user device, then the third notification is sent to the user device using the SMS messaging channel; and
upon the payment partner of the bill payment system successfully receiving the payment via one or more of the payment methods, sending a payment receipt information to the merchant in real time.

6. The method of claim 5, further comprising: upon the payment partner of the bill payment portal not receiving the payment via one or more of the payment methods even after sending the first notification and the second notification, aborting the one-click bill payment transaction, and sending a notification to the merchant that the one-click bill payment transaction has been aborted due to non-payment of bill amount by the user even after sending the first notification and the second notification.

7. The method of claim 5, wherein the first notification, the second notification, and the third notification are sent to the user device via the rich messaging channel only if the entity has a rich message channel enterprise account with the bill payment system.

8. The method of claim 5, wherein the first notification, the second notification, and the third notification are sent to the user device via the short message service (SMS) messaging channel only if the entity has an SMS Enterprise account with the bill payment system.

9. A system for executing a one-click bill payment for a payment transaction at a merchant location, the system comprising:
a non-transitory, computer-readable storage medium configured to store computer program instructions executable by at least one processor;
said at least one processor communicatively coupled to said non-transitory, computer-readable storage medium; and
one or more modules defining computer program instructions, which when executed by said at least one processor, cause said at least one processor to:
receive entity information and a selected messaging channel from an entity, wherein the selected messaging channel is one of a WhatsApp messaging channel, a short message service (SMS) messaging channel, and a WhatsApp messaging channel with fallback to SMS messaging channel;
send a plurality of templates to the entity and receiving a selection of three templates from the entity, wherein the three templates comprise one of a first template, a second template, a third template, and any combination thereof;
validate the three templates;
receive a user identifier and payment details for a payment transaction from a merchant, and incorporating the entity information and the payment details into the first template, the second template, and the third template;
generate and incorporate a one-click bill payment link into the first template and the second template, wherein the first template is incorporated into a first notification to be sent to a user, and wherein the second template is incorporated into a second notification to be sent to the user;
incorporate the third template into a third notification to be sent to the user;
send the first notification to the user via the selected messaging channel, wherein if the selected messaging channel is the WhatsApp messaging channel with fallback to SMS messaging channel, the first notification is first sent to the user using the WhatsApp messaging channel, and if the first notification does not reach the user, then the first notification is sent to the user using the SMS messaging channel;
upon the user clicking the one-click bill payment link contained in the first notification, send a list of payment methods to the user;
upon a payment partner of the bill payment system receiving the payment within a stipulated time via one or more of the payment methods, send the third notification to the user via the selected messaging channel, wherein if the selected messaging channel is the WhatsApp messaging channel with fallback to SMS messaging channel, the third notification is first sent to the user using the WhatsApp messaging channel, and if the third notification does not reach the user, then the third notification is sent to the user using the SMS messaging channel;
upon the payment partner of the bill payment system not receiving the payment within the stipulated time, send the second notification to the user via the selected messaging channel, wherein if the selected messaging channel is the WhatsApp messaging channel with fallback to SMS messaging channel, the second notification is first sent to the user using the WhatsApp messaging channel, and if the second notification does not reach the user, then the second notification is sent to the user using the SMS messaging channel;
upon the user clicking the one-click bill payment link contained in the second notification, send the list of payment methods to the user;
upon the payment partner of the bill payment system receiving the payment via one or more of the payment methods, send the third notification to the user via the selected messaging channel, wherein if the selected messaging channel is the WhatsApp messaging channel with fallback to SMS messaging channel, the third notification is first sent to the user using the WhatsApp messaging channel, and if the third notification does not reach the user, then the third notification is sent to the user using the SMS messaging channel; and
upon the payment partner of the bill payment system successfully receiving the payment via one or more of the payment methods, send a payment receipt information to the merchant in real time.

10. The system of claim 9, wherein if the payment partner of the bill payment system does not receive the payment via one or more of the payment methods even after sending the first notification and the second notification, the one-click bill payment transaction is aborted, and notification is sent to the merchant that the one-click bill payment transaction has been aborted due to non-payment of bill amount by the user even after sending the first notification and the second notification.

11. The system of claim 9, wherein the first notification, the second notification, and the third notification are sent to the user via the WhatsApp messaging channel only if the entity has a WhatsApp Enterprise account with the bill payment system.

12. The system of claim 9, wherein the first notification, the second notification, and the third notification are sent to the user via the short message service (SMS) messaging channel only if the entity has an SMS Enterprise account with the bill payment system.

13. A non-transitory, computer-readable storage medium having embodied thereon, computer program instructions of a bill payment system executable by at least one processor for executing a one-click bill payment for a payment transaction at a merchant location, said computer program instructions when executed by said at least one processor cause said at least one processor to:
receive entity information and a selected messaging channel from an entity, wherein the selected messaging channel is one of a WhatsApp messaging channel, a short message service (SMS) messaging channel, and a WhatsApp messaging channel with fallback to SMS messaging channel;
send a plurality of templates to the entity and receiving a selection of three templates from the entity, wherein the three templates comprise one of a first template, a second template, a third template, and any combination thereof;
validate the three templates;
receive a user identifier and payment details for a payment transaction from a merchant, and incorporating the entity information and the payment details into the first template, the second template, and the third template;
generate and incorporate a one-click bill payment link into the first template and the second template, wherein the first template is incorporated into a first notification to be sent to a user, and wherein the second template is incorporated into a second notification to be sent to the user;
incorporate the third template into a third notification to be sent to the user;
send the first notification to the user via the selected messaging channel, wherein if the selected messaging channel is the WhatsApp messaging channel with fallback to SMS messaging channel, the first notification is first sent to the user using the WhatsApp messaging channel, and if the first notification does not reach the user, then the first notification is sent to the user using the SMS messaging channel;
upon the user clicking the one-click bill payment link contained in the first notification, send a list of payment methods to the user;
upon a payment partner of the bill payment system receiving the payment within a stipulated time via one or more of the payment methods, send the third notification to the user via the selected messaging channel, wherein if the selected messaging channel is the WhatsApp messaging channel with fallback to SMS messaging channel, the third notification is first sent to the user using the WhatsApp messaging channel, and if the third notification does not reach the user, then the third notification is sent to the user using the SMS messaging channel;
upon the payment partner of the bill payment system not receiving the payment within the stipulated time, send the second notification to the user via the selected messaging channel, wherein if the selected messaging channel is the WhatsApp messaging channel with fallback to SMS messaging channel, the second notification is first sent to the user using the WhatsApp messaging channel, and if the second notification does not reach the user, then the second notification is sent to the user using the SMS messaging channel;
upon the user clicking the one-click bill payment link contained in the second notification, send the list of payment methods to the user;
upon the payment partner of the bill payment partner receiving the payment via one or more of the payment methods, send the third notification to the user via the selected messaging channel, wherein if the selected messaging channel is the WhatsApp messaging channel with fallback to SMS messaging channel, the third notification is first sent to the user using the WhatsApp messaging channel, and if the third notification does not reach the user, then the third notification is sent to the user using the SMS messaging channel; and
upon the payment partner of the bill payment system successfully receiving the payment via one or more of the payment methods, send a payment receipt information to the merchant in real time.

14. The non-transitory, computer-readable storage medium of claim 13, wherein if the payment partner of the bill payment system does not receive the payment via one or more of the payment methods even after sending the first notification and the second notification, the one-click bill payment transaction is aborted, and notification is sent to the merchant that the one-click bill payment transaction has been aborted due to non-payment of bill amount by the user even after sending the first notification and the second notification.
